(19) United States
(12) Patent Application Publication
(10) Pub. No.: US 2025/0329314 A1
(43) Pub. Date: Oct. 23, 2025

(54) Washboard with a Resonance Chamber

(71) Applicant: Cincinnati Washboards, Co., Doral, FL (US)

(72) Inventors: Rodrigo Garcia Guerra, Buenos Aires (AR); Luciano Pellegrini, Buenos Aires (AR)

(21) Appl. No.: 19/186,430

(22) Filed: Apr. 22, 2025

Related U.S. Application Data
(60) Provisional application No. 63/637,315, filed on Apr. 22, 2024.

(51) Int. Cl. G10D 13/06; G10D 13/10

(52) U.S. Cl. CPC G10D 13/06; G10D 13/10

(57) ABSTRACT

The present invention is a washboard instrument with a resonance chamber that improves the overall sound quality produced by the instrument. The resonance chamber improves the amplitude of any sound produced at a considerably lower rate of loss. Further, the instrument was designed to produce a wide variety of different sounds due to the number of different surfaces that can be struck. Additionally, the front panel can accommodate a number of different accessories that include, but not limited to, bells, jam blocks, and cymbals.

### RELATED APPLICATIONS

This application claims priority to U.S. Provisional Patent Application No. 63/637,315 entitled “Washboard with a Resonance Chamber” filed Apr. 22, 2024, and currently co-pending, the entirety of which is incorporated herein by reference.

### FIELD OF THE INVENTION

The present invention pertains generally to a washboard instrument that has a resonance chamber added to the back of the instrument.

### BACKGROUND OF THE INVENTION

Percussion instruments are a common type of musical instruments that are among the oldest musical tools used by humans. This can be attributed to both the simplistic nature of some of the instruments and their wide versatility. For example, percussion instruments can be used to play only rhythm, or can they can have music written for a player to play a melody and/or harmony.

One popular type of percussion instrument since the 1900s is the washboard. While the washboard was initially used for laundry, it was quickly picked up as a percussion instrument due to the ribbed metal surface that could produce a distinct sound for use in jug bands that were common during the early 1900s. Traditionally, an artist plays the instrument by tapping on the ribbed surface, the wooden portions, scraping the ribbed surface with thimbles, or some combination thereof.

The current version of these instruments available today typically only take advantage of the traditional washboard, meaning that the ribbed surface is encased by wood on each surface. While the instruments currently produce satisfactory sound, there are huge improvements that could be made. Specifically, the sound produced by washboards have low amplitude and sustain; thus, making it difficult for the instrument to stand out while played individually or in concert with other instruments.

### SUMMARY OF THE INVENTION

The present invention disclosed in this patent application is a musical washboard that drastically improves the sound quality through the use of a resonance chamber.

The resonance chamber is formed between a front panel and back panel that are installed onto the corresponding faces of an interior structure. These different components take the shape of a traditional washboard instrument, but they are noticeably thicker to accommodate the resonance chamber itself. The interior structure also has a recess that is sized for a ribbed sheet that is displayed through an opening on the front panel for a user to strike or scrape across. In addition to striking the ribbed sheet, different sounds can be produced by striking either of the panels, or the sides of the interior structure.

Critically, the resonance chamber provides several notable impacts on the overall sound produced by the instrument. First, the sound produced has a much higher amplitude due to individual sound waves combining with each other after each successive hit. Second, the combination of sound waves that occurs also lowers the rate of decay and as a consequence, the instrument has a much improved sustain. Finally, the pitch of the sound is lowered, so the instrument produces a much more distinct sound. These different impacts result in an instrument that significantly improves the state of the art for similar instruments.

In a preferred embodiment, the opening of the resonance chamber is fixed to provide the desired effect. But in alternative embodiments the opening can be wider, narrower, or variable, so a different pitch can be achieved. For example, the wider the opening, the lower the pitch; conversely, the narrower the opening, the higher the pitch.

Additionally, the back panel thickness and type of wood used to construct the instrument can also have an impact on the pitch produced. The thinner the back panel, the higher the pitch; conversely, the thicker the back panel, the lower pitch produced. For wood used, higher-density woods produce a higher pitch, while the lower-density woods produce a lower pitch.

The metal sheet used also has its own impact on the overall sound of the instrument. The more separated the grooves are, the fewer strikes can be generated when playing the present invention, which results in a slower tempo when compared to other instruments. Alternatively, the metal sheet can have closer groves which allows a user to strike the instrument more frequently, resulting in a higher tempo.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a top left perspective view of the washboard with a resonance chamber fully assembled;

FIG. 2 is an exploded view of the washboard with a resonance chamber showing the different components that make up the assembly;

FIG. 3 is a section view of the washboard with a resonating chamber showing the chamber;

FIG. 4 is a detail view of the washboard with a resonance chamber that illustrates how the ribbed plate sits inside the assembly;

FIG. 5 is a top view of the washboard with a resonance chamber that shows the opening for the resonance chamber; and

FIG. 6 is a bottom view of the washboard with a resonance chamber.

### DETAILED DESCRIPTION

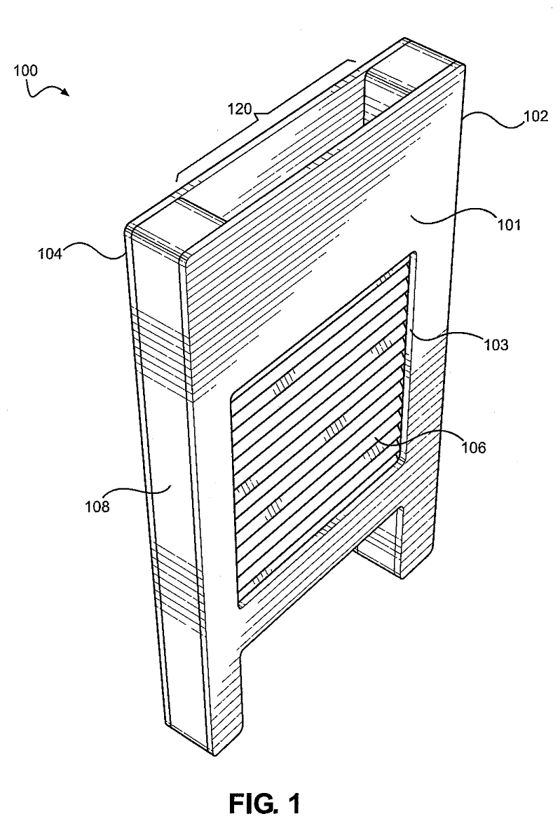

Referring initially to FIG. 1, a top perspective view of the fully assembled invention is shown and generally designated as washboard with a resonance chamber 100 (washboard 100). There are a multitude of different components that make up present invention, but the main feature is resonance chamber 120. Resonance chamber 120 is located at the top of washboard 100 and is formed by the opening between front panel 102 and back panel 104. When in use, sounds can be produced by a user wherever they decide to strike the instrument. The decision of where to strike washboard 100 is dependent on the type of sound desired. Striking front panel 102 produces a different sound than when striking ribbed sheet 106, back panel 104, or the sides of internal structure 108. Overall, washboard 100 is capable of producing a diverse range of acoustic sounds, from sharp, staccato rhythms to sustained, resonant tones, depending on the interaction between ribbed sheet 106 and various striking implements. This variation in sound is further enhanced by the design of resonance chamber 120, which amplifies and modifies the tonal quality and volume of the produced sounds.

All components, aside from ribbed sheet 106, are constructed out of wood. Density of wood is the main characteristic considered when selecting a wood to use in the manufacturing process. This is because the density of different woods has a profound effect on the sound produced by washboard 100. In a preferred embodiment, the density of the wood used ranges from 200 kg/m³ to 300 kg/m³. However, it is fully envisioned that in alternative embodiments washboard 100 can be constructed out of wood with a density lower than 200 kg/m³ to have the instrument produce sound at a lower pitch, or alternatively washboard 100 can be constructed out of wood with a density higher than 300 kg/m³ to produce a sound with a higher pitch.

Resonance chamber 120 is the main feature that differentiates washboard 100 from the prior art, and is the source of the drastically improved sound quality produced by the instrument. Resonance chamber 120 not only amplifies the volume of any note struck so that a user can hear the sound more clearly, but it also greatly improves the sustain of said note. Finally, resonance chamber 120 lowers the overall pitch, which allows washboard 100 to produce a much more distinct sound.

These features are all due to the design of the chamber itself. To better illustrate the mechanics of resonance chamber 120, the following non-limiting example assumes that a user is only producing sound by repeatedly striking ribbed sheet 106. Each strike of ribbed sheet 106 produces a unique longitudinal sound wave that is projected into resonance chamber 120. Subsequently, the longitudinal sound wave that was produced reflects off of the interior of front panel 102 and back panel 104 as it travels the length of the chamber. Additionally, if a first longitudinal sound wave is traveling through resonance chamber 120, a second longitudinal sound wave, produced by a second strike, combines with the first. This combination which increases both the amplitude and sustain of the first longitudinal sound wave. Further, the first longitudinal soundwave can be combined with any number of subsequent soundwaves that are produced by subsequent strikes regardless of where the strike occurs.

While the aforementioned illustration applies to the striking of ribbed sheet 106, the same process applies to wherever a user strikes washboard 100 while playing music. The wide variety of different sound that can be produced by washboard 100 allows the instrument to be used in a number of different settings. For instance, washboard 100 can be used to provide the tempo for the rest of the instruments in a band to follow, or it can be played individually in a standalone performance.

Front panel 102 also has a handful of important design considerations. The most notable of which, is front opening 103 and front face 101. Front opening 103 was not only designed to provide as much access to ribbed sheet 106 as possible, but it was also designed to have front panel lip 112 that actually functions to secure ribbed sheet 106 inside recess 110 (shown in greater detail at FIG. 4). Front face 101 provides a considerable amount of surface area for a user to strike front panel 102, which provides a large number of different sounds that can be produced. The large surface area of front face 101 also lets a user attach a variety of different attachments that includes, but is not limited to, bells, jam blocks, and cymbals.

Ribbed sheet 106 is constructed out of galvanized steel and is designed to produce a specific sound. However, in other embodiments the design of ribbed sheet 106 can be altered to affect the different sound that washboard 100 can produce. In a nonlimiting example, ribbed sheet 106 can be designed to have a higher number of ribbed portions that increases the number of possible notes. Conversely, in another nonlimiting example, ribbed sheet 106 can be designed to have a lower number of ribbed portions that decrease the number of possible notes, but produces a much more distinct sound. Alternatively, ribbed sheet 106 may be fabricated from various other metals or undergo post-processing treatments, such as an induced rusting process.

All of the aforementioned features leave a user is left with a tremendous amount of flexibility on how best to utilize the musical capacity of washboard 100. This is due to the incredible number of different sounds that can be produced by front panel 102, or ribbed sheet 106 individually, but also when they are considered in conjunction with each other.

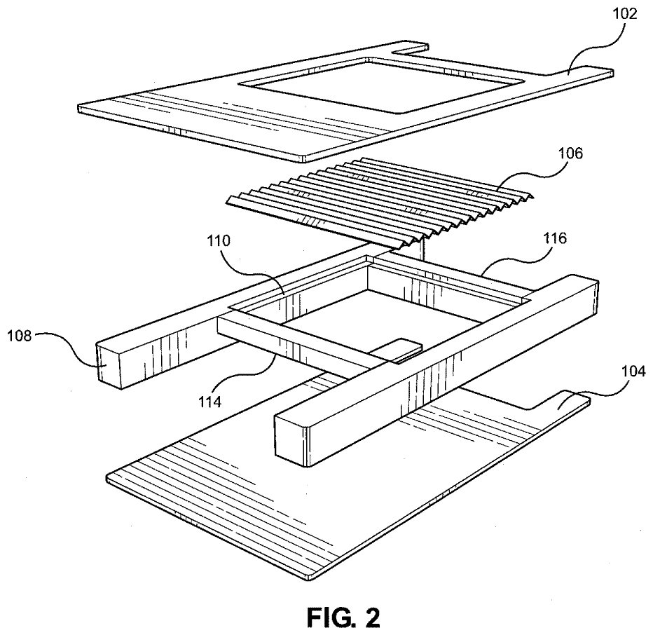

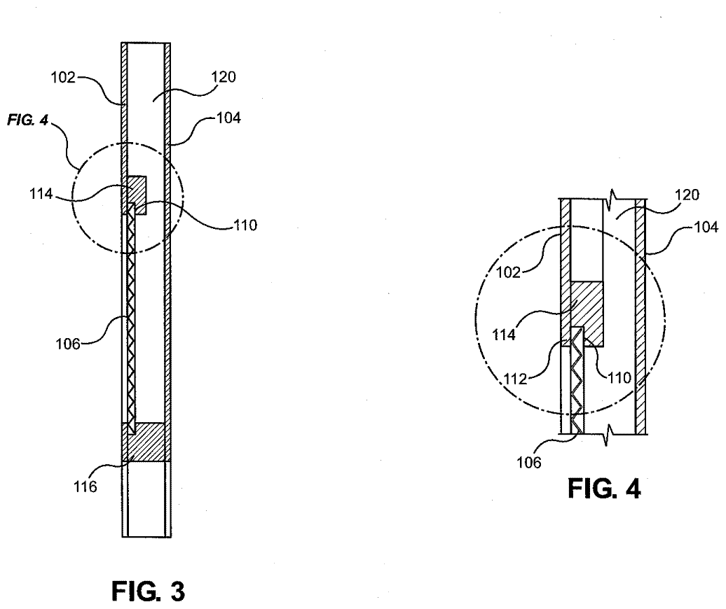

Referring now to FIG. 2, an exploded view of washboard 100 is shown to illustrate how the instrument is put together. Interior structure 108 is the main component for washboard 100. Interior structure 108 has some important design considerations that impact the entire function of washboard 100. The first is bottom beam 116, which seals the bottom of washboard 100 to ensure that sound only travels out of resonance chamber 120. The second is top beam 114, which critically has a width that is smaller than bottom beam 116. Top beam 114 is part of the formation of resonance chamber 120 and is discussed in greater detail during the discussion of FIG. 3. The final component is recess 110 which is sized to let ribbed sheet 106 to fit inside.

Back panel 104 is attached to the backside of interior structure 108. In a preferred embodiment, back panel 104 as a specific thickness that produces the desired sound quality. However, it is fully envisioned that the thickness of back panel 104 can be varied in alternative embodiments that produce different sounds. If back panel 104 ends up being thicker, then a higher pitch is produced. Conversely, if back panel 104 ends up being thinner, then a lower pitch is produced. It is all dependent on the sound quality that a user wants prior to the manufacturing process beginning.

Ribbed sheet 106 is sized to fit onto interior structure 108 via recess 110. Recess 110 is size to be slightly larger than front opening 103. This allows ribbed sheet 106 to be secure not only when washboard 100 is fully assembled, but more importantly, while the instrument is in use and a user is striking ribbed sheet 106. Front panel 102 is then secured to the top of interior structure 108 once ribbed sheet 106 is placed.

Referring now to FIG. 3, a section view of washboard 100 is shown to better illustrate resonance chamber 120. Resonance chamber 120 begins at bottom beam 116 and runs all the way to the top of washboard 100. In a preferred embodiment, the opening for resonance chamber is only roughly an inch wide. However, it is fully envisioned that in other embodiments the opening for resonance chamber 120 can be greater than an inch to produce sound at a lower pitch, or alternatively, less than an inch to produce a sound at a higher pitch.

This section view better illustrates the number of different sounds that can be produced by washboard 100. These different sounds can be produced by striking front panel 102, back panel 104, or ribbed sheet 106 either individually or in combination with each other. Regardless, of how and where each sound wave is generated, these sound waves will combine to provide a much unique sound that is distinct and novel from similar models currently available.

Referring now to FIG. 4, a detail view of washboard 100 is shown to better illustrate how ribbed sheet 106 is secured inside the instrument. Critically, the depth of recess 110 is designed to ensure that a peak of ribbed sheet 106 is pressed down by front panel lip 112. The compressive force applied through the peak of ribbed sheet 106 pushes ribbed 106 down just enough so that the end portion of ribbed sheet 106 is pressed into the edge of recess 110. This method of securing ribbed sheet 106 ensures that it is properly placed inside the instrument, and it provides the requisite stability needed for operation. Further, the compressive force needed to secure ribbed sheet 106 is not so high as to compromise the structural integrity of the sheet itself.

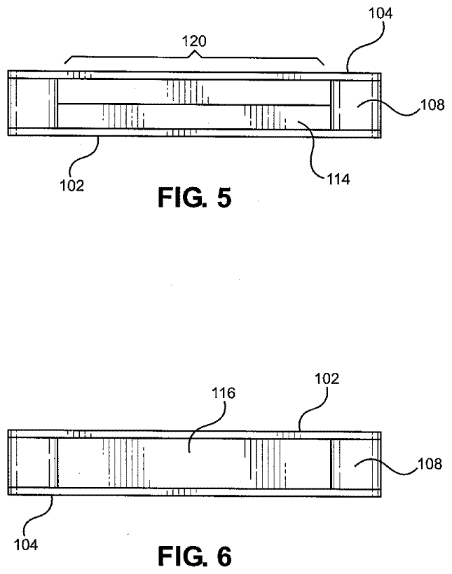

Referring now to FIGS. 5 and 6, a top and bottom view, respectively, are shown. In FIG. 5, a top view showing resonance chamber 120 is shown, while in FIG. 6, a bottom view showing bottom beam 116 is shown. Bottom beam 116 ensures that no sound produced by striking washboard 100 leaves through the bottom.

While there have been shown what are presently considered to be preferred embodiments of the present invention, it will be apparent to those skilled in the art that various changes and modifications can be made herein without departing from the scope and spirit of the invention.

1. A washboard with a resonance chamber comprising:
an interior structure having a front side, a back side, and an opening;
a front cover having an opening that is mounted onto the front side of the interior structure;
a ribbed sheet that fits between the front cover and the interior structure;
a back panel that is mounted onto the back side of the interior structure; and
a resonance chamber that is formed between a top edge of the front cover and a top edge of the back cover that directs the travel of a soundwave that is generated by striking the ribbed sheet, front panel, back panel, or some combination of the three.

2. The washboard with a resonance chamber of claim 1, wherein the opening of the front cover corresponds with the size of the ribbed sheet.

3. The washboard with a resonance chamber of claim 2, wherein the opening of the interior structure further comprises a border that is recessed some distance below the front side of the interior structure.

4. The washboard with a resonance chamber of claim 3, wherein the ribbed sheet fits within the border of the interior structure.

5. The washboard with a resonance chamber of claim 4, wherein the front cover further comprises a front face that is located some distance above the opening of the front cover.

6. The washboard with a resonance chamber of claim 5, further comprising at least one bell, at least one jam block, or at least one cymbal mounted onto the front face of the front cover.

7. The washboard with a resonance chamber of claim 5, wherein the interior structure, the front cover, and the back panel are constructed out of wood having a density between 200 kg/m³ to 300 kg/m³.

8. A washboard with a resonance chamber comprising:
an interior structure having an opening through a front surface and a back surface;
a front cover mounted onto the front surface of the interior structure;
a ribbed sheet located in between the front surface of the interior structure and the front cover;
a back cover mounted onto the back surface of the interior structure;
a sound channel that is formed between a top edge of the front cover and a top edge of the back cover, and
wherein the front cover has an opening that exposes the ribbed sheet.

9. The washboard with a resonance chamber of claim 8, wherein the opening of the front cover corresponds with the size of the ribbed sheet.

10. The washboard with a resonance chamber of claim 9, wherein the opening of the interior structure further comprises a border that is recessed some distance below the front side of the interior structure.

11. The washboard with a resonance chamber of claim 10, wherein the ribbed sheet fits within the border of the interior structure.

12. The washboard with a resonance chamber of claim 11, wherein the front cover further comprises a front face that is located some distance above the opening of the front cover.

13. The washboard with a resonance chamber of claim 12, further comprising at least one bell, at least one jam block, or at least one cymbal mounted onto the front face of the front cover.

14. The washboard with a resonance chamber of claim 12, wherein the interior structure, the front cover, and the back panel are constructed out of wood having a density between 200 kg/m³ to 300 kg/m³.
